(19) United States
(12) Patent Application Publication
(10) Pub. No.: US 2013/0025979 A1
(43) Pub. Date: Jan. 31, 2013

(54) Low-Profile Dual-Pivot Caliper Brake

(71) Applicant: Kristopher Wehage, Seattle, WA (US)

(72) Inventor: Kristopher Wehage, Seattle, WA (US)

(21) Appl. No.: 13/191,530

(22) Filed: Jul. 27, 2011

(51) Int. Cl. B62L 1/14; B62L 1/16

(52) U.S. Cl. 188/24.12

(57) ABSTRACT

A low-profile dual-pivot caliper brake includes a first caliper arm, a second caliper arm, and an accelerator linkage. The first and second caliper arms are linked together. The accelerator linkage includes first and second link members that are two separate elements. The first and second link members are joined together and can move with respect to each other. Additionally, the first link member is pivoted mounted about a first pivotal connection. Additionally, the second link member and the second caliper arm are joined together and can move with respect to each other. Furthermore, the second caliper arm is pivotally mounted about a second pivotal connection.

### BACKGROUND OF THE INVENTION

1. Field of the Invention

The present invention relates to a dual-pivot caliper brake and, in particular, to a dual-pivot caliper brake having a lower profile and which is more aerodynamic and lighter.

2. Description of the Related Art

A conventional dual-pivot caliper brake used on a bicycle is known to offer a higher mechanical advantage, but caliper arms of the dual-pivot caliper brake generally extend quite far to the side of the bicycle and are not aerodynamic for the bicycle. Therefore, it is ideal to have the entire profile of the dual-pivot caliper brake within the front silhouette of the bicycle for best aerodynamics.

The present invention is, therefore, intended to obviate or at least alleviate the problems encountered in the prior art.

### SUMMARY OF THE INVENTION

According to the present invention, a low-profile dual-pivot caliper brake includes a first caliper arm, a second caliper arm, and an accelerator linkage. The first and second caliper arms are linked together and are disposed symmetrically with respect to each other. The accelerator linkage includes first and second link members that are two separate elements. The first and second link members are joined together and have a first connection defined therebetween. The first connection has various degrees of freedom such that the first and second link members can move with respect to each other. Additionally, the first link member is pivotally mounted about a first pivotal connection. Additionally, the second link member and the second caliper arm are joined together and have a second connection defined therebetween. The second connection has various degrees of freedom such that the second link member and the second caliper arm can move with respect to each other. Furthermore, the second caliper arm is pivotally mounted about a second pivotal connection. Moreover, the dual-pivot caliper brake includes the first and second caliper arms that selectively move towards or away from each other in the operation thereof.

It is an object of the present invention to provide a dual-pivot caliper brake that has a lower profile.

It is another object of the present invention to provide a dual-pivot caliper brake that is more aerodynamic.

It is yet another object of the present invention to provide a dual-pivot caliper brake that is lighter.

### BRIEF DESCRIPTION OF THE DRAWINGS

FIG. 1 is a perspective view of a dual-pivot caliper brake in accordance with the present invention.

FIG. 2 is an exploded perspective view of the dual-pivot caliper brake of FIG. 1.

FIG. 3 is a cross-sectional view taken along line 3-3 of FIG. 1 and shows a wheel disposed between first and second caliper arms of the dual-pivot caliper brake and a brake cable linked with the first caliper arm as well as an accelerator linkage of the dual-pivot caliper brake, with the wheel and the brake cable shown in phantom.

FIG. 4 is an extended cross-sectional view of FIG. 3 and shows the dual-pivot caliper brake in a position clamping the wheel.

FIG. 5 is a cross-sectional view taken along line 5-5 of FIG. 1.

FIG. 6 is an extended cross-sectional view of FIG. 5 and shows the dual-pivot caliper brake in a position clamping the wheel.

FIG. 7 is a cross-sectional view taken along line 7-7 of FIG. 3.

### DETAILED DESCRIPTION OF THE PREFERRED EMBODIMENT

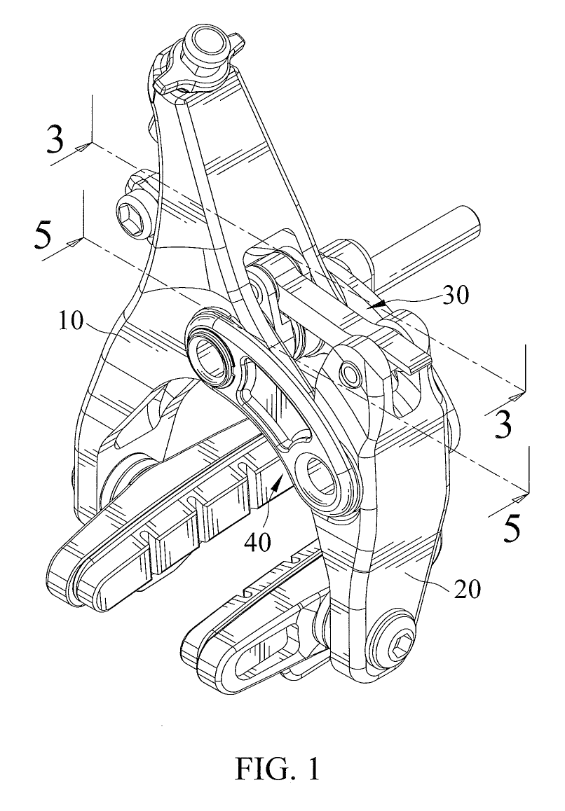

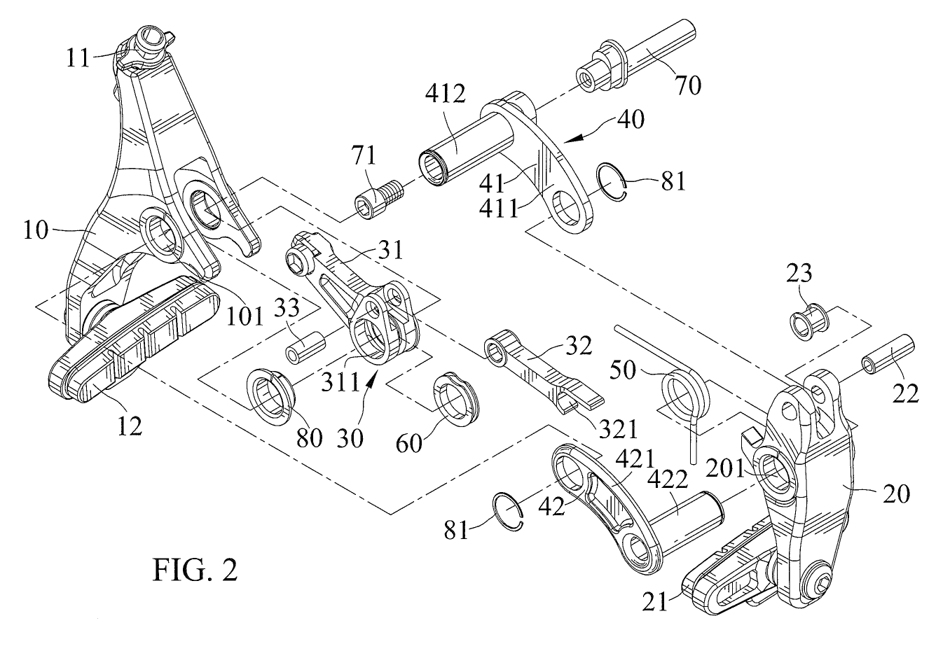

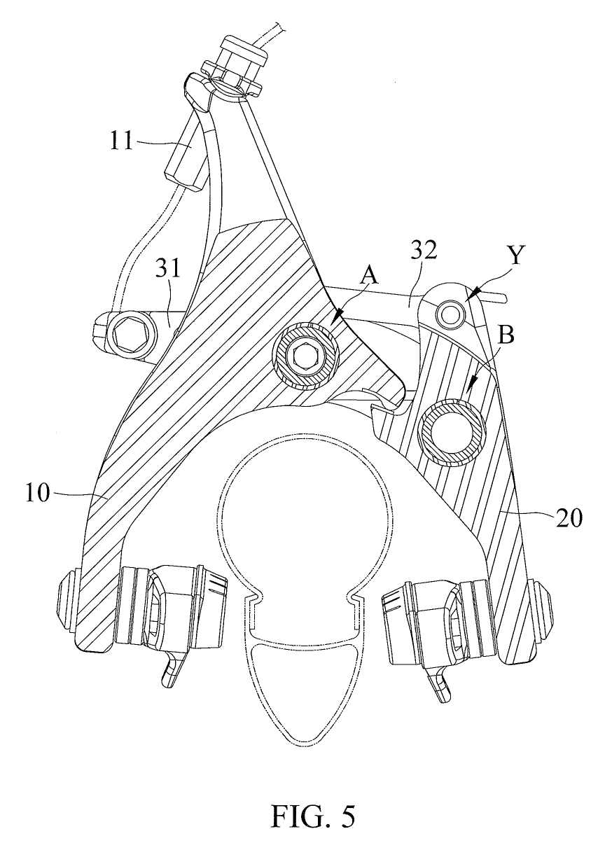

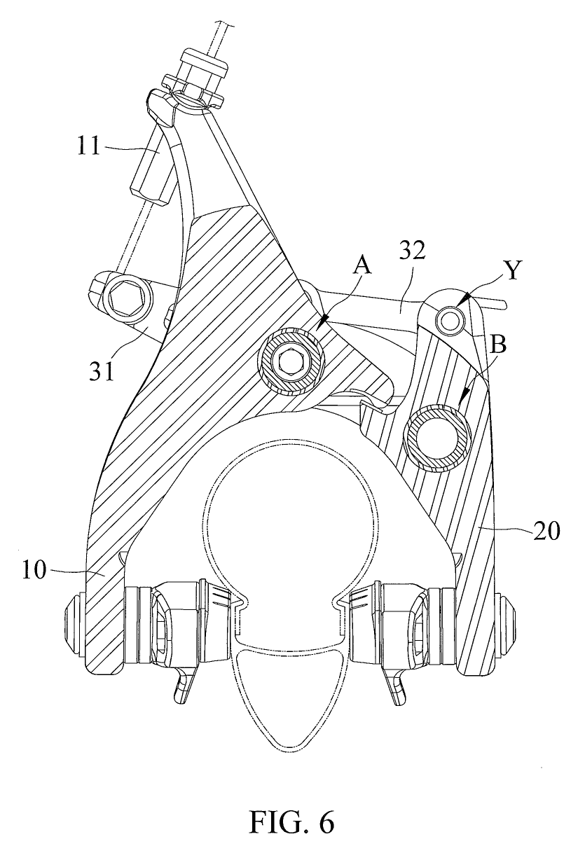

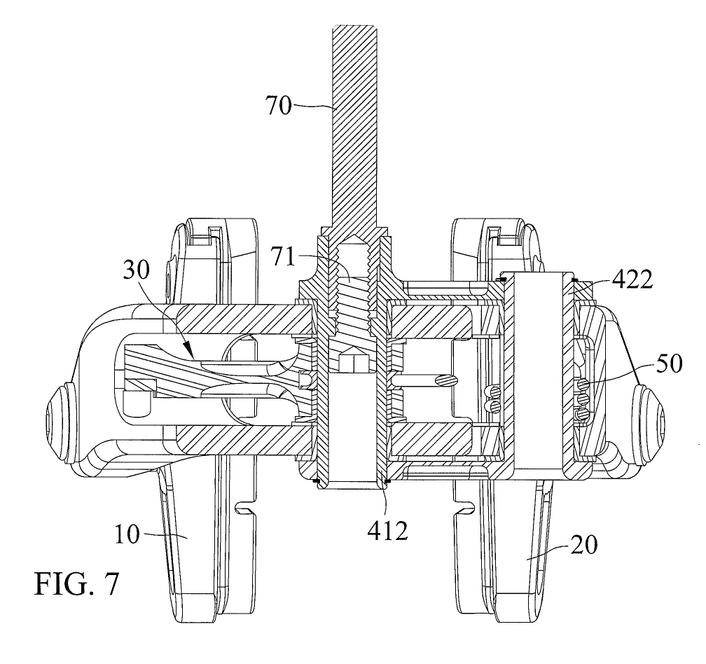

FIGS. 1 through 7 show a dual-pivot caliper brake in accordance with the present invention. The low-profile dual-pivot caliper brake includes a first caliper arm 10, a second caliper arm 20, and an accelerator linkage 30.

The first and second caliper arms 10 and 20 are linked together and are disposed symmetrically with respect to each other. Additionally, the first and second caliper arms 10 and 20 each includes a brake pad 12 and 21 mounted thereon. The brake pads 12 and 21 are disposed symmetrically to each other. Furthermore, the first caliper arm 10 has a brake cable connected thereto. The brake cable has an end connected to an input device.

The accelerator linkage 30 includes first and second link members 31 and 32 that are two separate elements. The first and second link members 31 and 32 are joined together and have a first connection X defined therebetween. The first connection X has various degrees of freedom such that the first and second link members 31 and 32 can move with respect to each other. Further, a shaft 33 defines the first connection X. Additionally, the first link member 31 is pivotally mounted about a first pivotal connection A. Further, a first axle 412 defines the first pivotal connection A. The first link member 31 is pivotally mounted on a first axle 412. The first axle 412 is inserted into an orifice 311 defined in the first link member 31 to join to the first link member 31. The first link member 31 also includes the brake cable connected thereto. Additionally, the second link member 32 and the second caliper arm 20 are joined together and have a second connection Y defined therebetween. The second connection Y has various degrees of freedom such that the second link member 32 and the second caliper arm 20 can move with respect to each other. Moreover, to open the brakes to facilitate quick tire changes, the second link member 32 and the second caliper arm 20 are preferably releasably joined together such that the second link member 32 includes an end forming a slot 321 and the second caliper arm 20 includes a joining end 22 received in the slot 321 when the second link member 32 and the second caliper arm 20 are joined together. Further, a bushing 23 is circumferentially disposed outside the joining end. Therefore, the bushing 23 is received in the slot 321 when the second link member 32 and the second caliper arm 20 are joined together. Furthermore, the second caliper arm 20 is pivotally mounted about a second pivotal connection B. Further, a second axle 422 defines the second pivotal connection B. The second caliper arm 20 is pivotally mounted on a second axle 422. The second axle 422 is inserted into a bore 201 defined in the second caliper arm 20 to join to the second caliper arm 20.

In addition, the first caliper arm 10 is pivotally mounted on the first axle 412. The first axle 412 is inserted into a hole 101 defined in the first caliper arm 10 to join to the first caliper arm 10.

In addition, the first and second axles 412 and 422 are defined in an exoskeleton bridge 40 which includes a first end joined to the first caliper arm 10 and a second end joined to the and second caliper arm 20. The exoskeleton bridge 40 is a two-piece element, namely it includes first and second bridges 41 and 42. Each of the first and second bridges 41 and 42 has a body 411 and 421. The body 411 of the first bridge 41 has a first end joined to the first axle 412 and a second end joined to the second axle 422. Likewise, the body 421 of the bridge 42 has a first end joined to the first axle 412 and a second end joined to the second axle 422.

Moreover, the dual-pivot caliper brake includes a biasing member 50 restrained between the first axle 412 and the second caliper arm 20. A groove 60 is disposed on the first axle 412. The biasing member 50 includes first and second distal ends abutting against the spring groove 60 and the second caliper arm 20 respectively in order to be restrained between the first axle 412 and the second caliper 20. Additionally, the biasing member 50 is mounted on the second axle 422. The second axle 422 is inserted through at least one loop formed by the biasing member 50 to join to the biasing member 50.

Moreover, the dual-pivot caliper brake includes a fixing bolt 70 joined to the first axle 412. The fixing bolt 70 is utilized for mounting the dual-pivot caliper brake on a bicycle. Additionally, the first axle 412 includes a fastener 71 inserted therein and engages with the fixing bolt 70 to join the fixing bolt 70 to the first axle 412.

Furthermore, a barrel adjuster screw 11 is mounted on the first caliper arm 10 and is disposed between the first link member 31 and the input device. The brake cable is inserted through the barrel adjuster screw 11 through an aperture defined therein.

Furthermore, at least one bushing 80 and at least one retain ring 81 is disposed between connections of the aforementioned elements. The retaining rings could also be replaced with a threaded element (not shown).

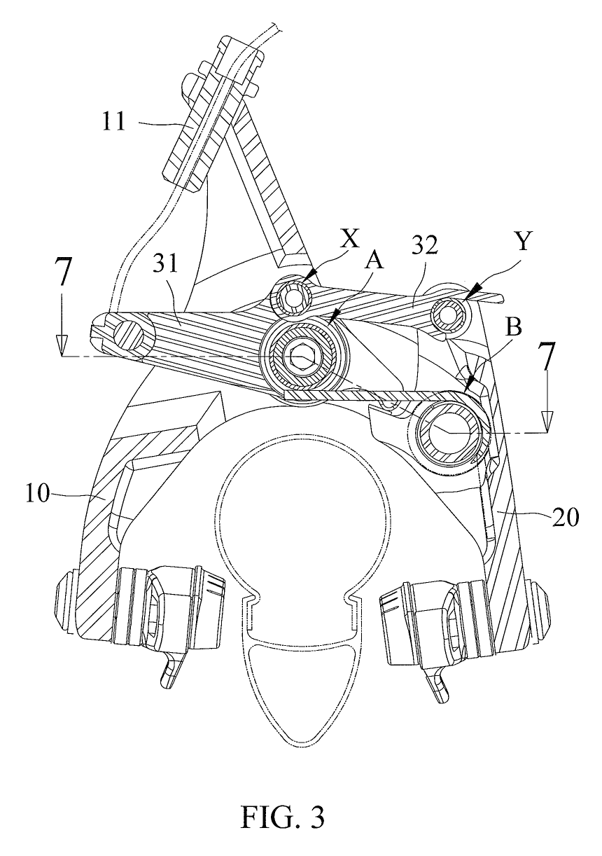

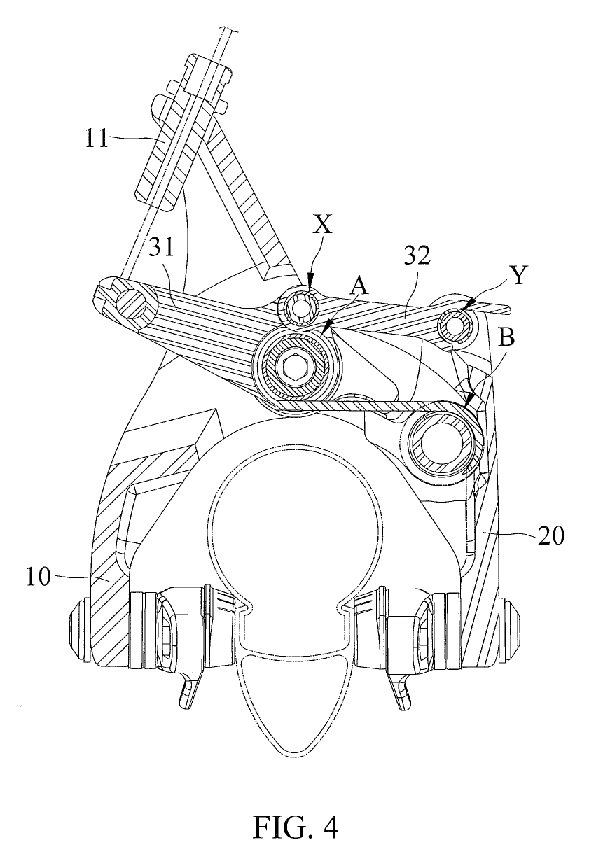

In the operation of the dual-pivot caliper brake, the input device is operated, the first caliper arm 10 pivots about the first pivotal connection A, the first link member 31 pivots about the first pivotal connection A, the second link member 32 moves with respect to the first link member 31, the first connection X moves circumferentially with respect to the first pivotal connection A, the second link member 32 causes the second caliper arm 20 to pivot about the second pivotal connection B, and the first and second caliper arms 10 and 20 selectively move towards or away from each other. Additionally, when the dual-pivot caliper brake is used with a wheel, the wheel is disposed between first and second caliper arms 10 and 20, as shown in FIG. 3. FIG. 4 shows the dual-pivot caliper brake is in a position clamping the wheel.

In view of the forgoing, the accelerator linkage 30 can increase mechanical advantage of the dual-pivot caliper brake and has a lower frontal profile for improved aerodynamics and a more compact design for light weight. Therefore, the dual-pivot caliper brake can have a lower profile and is more aerodynamic and is lighter. The accelerator linkage 30 includes the first and second link members 31 and 32 that are two separate elements. The first and second link members 31 and 32 are joined together and can move with respect to each other. The first link member 31 is pivotally mounted about the first pivotal connection A. The second link member 32 and the second caliper arm 20 are joined together and can move with respect to each other. The second caliper arm 20 is pivotally mounted about the second pivotal connection B.

The accelerator linkage 30 is preferably used in conjunction with the exoskeleton bridge construction 40, the exoskeleton bridge 40 having a front and back bridge portion i.e., first and second bridge members 41 and 42 and interlocking pivots i.e. first and second axles 412 and 422. The two-piece bridge construction allows braking forces to be transmitted through the center plane of the bicycle, increases rigidity and decreases weight of the structure, and subjects the various link members to pure bending loads, instead of bending and torsion loads. However, the accelerator linkage 30 could also be modified to work with a conventional bridge construction and not depart from the scope of the invention.

While the specific embodiment has been illustrated and described, numerous modifications come to mind without significantly departing from the spirit of invention, and the scope of invention is only limited by the scope of the accompanying claims.

What is claimed is:

1. A low-profile dual-pivot caliper brake comprising:
a first caliper arm;
a second caliper arm linked to and disposed symmetrically with the first caliper arm; and
an accelerator linkage including first and second link members that are two separate elements, with the first and second link members joined together and having a first connection defined therebetween, with the first connection having various degrees of freedom, with the first and second link members moving with respect to each other, with the first link member pivotally mounted about a first pivotal connection, with the second link member and the second caliper arm joined together and having a second connection defined therebetween, with the second connection having various degrees of freedom, with the second link member and the second caliper arm movable with respect to each other, with the second caliper arm pivotally mounted about a second pivotal connection.

2. The low-profile dual-pivot caliper brake as claimed in claim 1, wherein the second link member is selectively releasably joined to the second caliper arm.

3. The low-profile dual-pivot caliper brake as claimed in claim 1, wherein the first caliper arm has a brake cable connected thereto, with the brake cable having an end connected to an input device, with the input device operated and the first caliper arm pivoting about the first pivotal connection in response to the operation of the input device.

4. The low-profile dual-pivot caliper brake as claimed in claim 3, wherein the first caliper arm includes a barrel adjuster screw mounted thereon and disposed between the first link member and the input device, and wherein the brake cable is inserted through the barrel adjuster screw, with the barrel adjusting including an aperture defined therein receiving the brake cable.

5. The low-profile dual-pivot caliper brake as claimed in claim 1, wherein the first link member is pivotally mounted on a first axle, with the first axle insertably mounted in an orifice defined in the first link member to join to the first link member, with the first axle defining the first pivotal connection, and wherein the second caliper arm is pivotally mounted on a second axle, with the second axle insertably mounted in a bore defined in the second caliper arm to join to the second caliper arm, with the second axle defining the second pivotal connection.

6. The low-profile dual-pivot caliper brake as claimed in claim 5 further comprising a biasing member restrained between the first axle and the second caliper arm.

7. The low-profile dual-pivot caliper brake as claimed in claim 6 further comprising a groove disposed on the first axle, and wherein the biasing member includes first and second distal ends abutting against the spring groove and the second caliper arm respectively in order to be restrained between the first axle and the second caliper.

8. The low-profile dual-pivot caliper brake as claimed in claim 1, wherein the biasing member is mounted on the second axle, with the second axle inserting through at least one loop formed by the biasing member to join to the biasing member.

9. The low-profile dual-pivot caliper brake as claimed in claim 5, wherein the first caliper arm is pivotally mounted on the first axle, with the first axle insertably mounted in a hole defined in the first caliper arm to join to the first caliper arm.

10. The low-profile dual-pivot caliper brake as claimed in claim 1 further comprising a fixing bolt joined to the first axle, with the fixing bolt utilized for mounting the dual-pivot caliper brake on a bicycle.

11. The low-profile dual-pivot caliper brake as claimed in claim 1, wherein the first and second caliper arms each includes a brake pad mounted thereon, with the brake pads disposed symmetrically to each other.
